(19) United States
(12) Patent Application Publication
(10) Pub. No.: US 2011/0122092 A1
(43) Pub. Date: May 26, 2011

(54) ELECTRONIC DEVICE WITH OPTICAL TOUCH MODULE

(75) Inventor: Kuo-Huang Lu, Taipei (TW)

(73) Assignee: MICRO-STAR INTERNATIONA'L CO., LTD., Taipei County (TW)

(21) Appl. No.: 12/708,000

(22) Filed: Feb. 18, 2010

(30) Foreign Application Priority Data
Nov. 20, 2009 (TW) 098221756

(51) Int. Cl. G06F 3/042

(52) U.S. Cl. 345/175; 178/18.09

(57) ABSTRACT

An electronic device with an optical touch module is presented. A touch pad is disposed on the electronic device and at least one light transmission element is disposed on at least one side of the touch pad. The touch pad has a sensing area and senses a moving track direction of an object on the sensing area. Therefore, the touch pad, according to the moving track direction of the object, activates a light source to irradiate to the light transmission element corresponding to the moving track direction, such that the light transmission element illuminates on at least one side of the touch pad, thus achieving the effect of direction indication with light sources.

### CROSS-REFERENCE TO RELATED APPLICATIONS

This non-provisional application claims priority under 35 U.S.C. §119(a) on Patent Application No(s). 098221756 filed in Taiwan, R.O.C. on Nov. 20, 2009, the entire contents of which are hereby incorporated by reference.

### BACKGROUND OF THE INVENTION

1. Field of Invention

The present invention relates to an electronic device, and more particularly to an electronic device with an optical touch module.

2. Related Art

Currently, with the popularization of notebooks and the increase of the usage demands, the functions of the notebooks also become more powerful, and the operation interface and the operation modes become more complicated. In order to avoid the volume of the notebook from being larger after the increase of the functions, or even in order to make the volume of the notebook become smaller for easy of carrying, the hardware must be designed to be more simplified and personalized, in which the design of a structure for saving the space leads to the generation of the touch structure.

At present, the touch structure applied to the notebook replaces the traditional operation interface (for example, the operation device extended from the notebook such as the mouse of the notebook) that occupies much space and is difficult to carry, and this, in addition to reducing the demands on the space by the notebook, makes the volume of the notebook become smaller due to the decrease of the additional extra device. Therefore, the convenience of the operation of the notebook and the mobility of the notebook are increased, which further makes the notebook need to have functions that can also play the role of the convenience of the operation in different environments.

Since the operation environments of the notebook are quite diversified, undesirable illumination is a problem that can be most commonly encountered. How to make the notebook achieve the operation aim of the touch structure at the place with undesirable illumination is the direction that relevant manufacturers engaged in this industry urgently research and improve.

### SUMMARY OF THE INVENTION

Accordingly, the present invention is an electronic device with an optical touch module, which makes the touch pad have the effect of luminous indication. Therefore, the touch pad can illuminate and be recognized more easily when being used in different environments (such as environment with no illumination or environment with low illumination).

The present invention provides an electronic device with an optical touch module, which comprises a housing, a touch pad, at least one light transmission element, and at least one light emitting element. The touch pad is disposed on the housing and has at least one induction circuit. The induction circuit constitutes a touch area on the touch pad, and the touch pad is used to detect a moving track direction of an object on the touch area. The light transmission element is disposed on the housing and is adjacent to at least one side of the touch pad. The light emitting element is disposed in the housing and corresponds to the light transmission element. When the object moves on the touch area, the touch pad can, according to the moving track direction of the object, activate the light emitting element to emit a light to the light transmission element corresponding to the moving track direction, such that the light transmission element illuminates on at least one side of the touch pad.

The efficacy of the present invention lies in driving a light source (i.e., the light emitting element) to irradiate to the light transmission element corresponding to the moving track direction according to the moving track direction of the object on the touch area, such that the light transmission element illuminates on at least one side of the touch pad. In this way, in the places with no illumination or undesirable illumination, the current touch direction of the user can be indicated by a luminous structure corresponding to the moving track direction, so as to increase the convenience in operating the electronic device.

### BRIEF DESCRIPTION OF THE DRAWINGS

The present invention will become more fully understood from the detailed description given herein below for illustration only, and thus are not limitative of the present invention, and wherein:

FIG. 1 is a schematic appearance view of an electronic device with an optical touch module according to an embodiment of the present invention;

FIG. 2 is a schematic enlarged view of the optical touch module according to an embodiment of the present invention;

FIG. 3 is a schematic top view of the optical touch module according to an embodiment of the present invention;

FIG. 4 is schematic sectional view of the optical touch module according to an embodiment of the present invention;

FIG. 5 is a schematic top view of an optical touch module according to another embodiment of the present invention; and

FIG. 6 is a schematic top view of an optical touch module according to still another embodiment of the present invention.

### DETAILED DESCRIPTION OF THE INVENTION

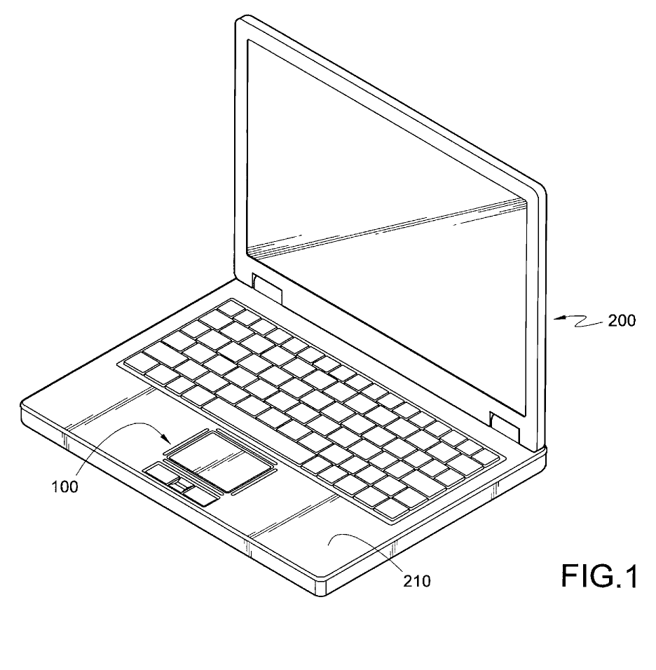

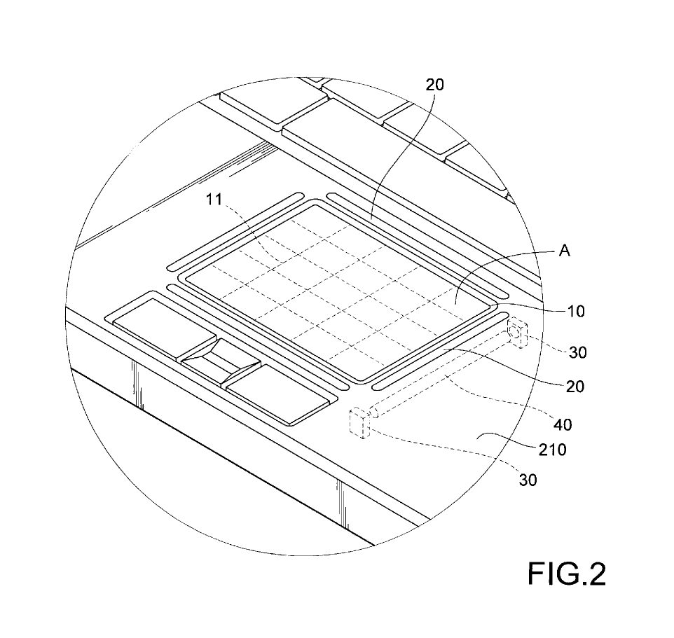

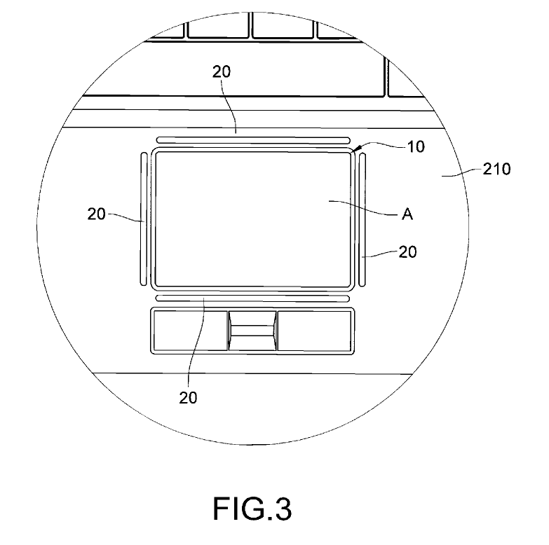

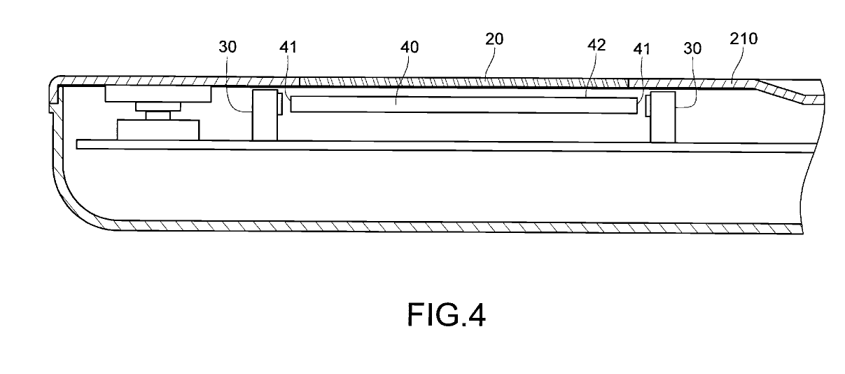

Referring to FIGS. 1 to 4, FIG. 1 is a schematic appearance view of an electronic device with an optical touch module according to an embodiment of the present invention, FIG. 2 is a schematic enlarged view of the optical touch module according to an embodiment of the present invention, FIG. 3 is a schematic top view of the optical touch module according to an embodiment of the present invention, and FIG. 4 is schematic sectional view of the optical touch module according to an embodiment of the present invention.

Referring to FIG. 1, in this embodiment, an optical touch module 100 is disposed on an electronic device 200. In this embodiment, the electronic device 200 is a notebook, but the present invention is not limited thereto. The optical touch module 100 comprises a touch pad 10, at least one light transmission element 20, and at least one light emitting element 30.

The touch pad 10 is disposed on a housing 210 of the electronic device 200, and the touch pad 10 has at least one induction circuit 11. In this embodiment, the induction circuit 11 is arrayed on the touch pad 10, and the induction circuit 11 can be a capacitance induction or a resistance induction. For example, the induction circuit 11 may be designed as a capacitance induction circuit, so as to constitute a tough area A on the touch pad 10. When an object (such as a finger or other objects like a digital pen) contacts with the touch area A, a capacitance value of the induction circuit 11 may vary.

It should be particularly noted that the touch pad 10 on such an electronic device 200 (for example, the notebook) is used to execute the cursor function of a mouse or the handwritten function of a tablet. For example, the touch pad 10 mainly uses the induction circuit 11 to detect a variation of a capacitance value on the touch area A, and the variation of the capacitance value is converted into an analog signal of a moving track. Next, the touch pad 10 transmits the analog signal of the moving track to a controller (not shown), and the controller converts the analog signal into a digital signal that can be processed by a computer operation unit. The moving track is used to implement the manipulation function of the cursor displacement or the manipulation function of the handwritten input.

The light transmission element 20 is disposed on one side of the touch pad 10. Particularly, a notch that can accommodate the light transmission element 20 is cut on the housing 210 of the electronic device 200, and the light transmission element 20 is adjacent to one side of the touch area A. It should be noted that the touch area A may be polygonal (such as quadrangular, pentagonal, or hexagonal) or a circular arc, and the light transmission element 20 can be disposed on the edge of the touch area A along the shape of the touch area A. For ease of illustration, in this embodiment, the number of the light transmission elements 20 may be four, and the light transmission elements 20 are designed to be strip-shaped, but the present invention is not limited thereto. The shape of the light transmission elements 20 is designed to be strip-shaped so as to surround the light transmission elements 20 around the touch pad 10. In this way, a luminous border area can be formed around the touch pad 10, thus forming a luminous block with a large area.

The light emitting element 30 is disposed in the electronic device 200, and the light emitting element 30 emits a light toward the light transmission element 20. In other words, the light emitting element 30 can also be disposed on at least one side of the touch area A. The light emitting element 30 is used to generate a light, and the light emitting element 30 may be a light emitting diode (LED), a cold cathode lamp, or a lamp.

In this embodiment, the optical touch module 100 further comprises at least one light guide element 40, and the light guide element 40 is disposed in the electronic device 200 and corresponds to the bottom of the light transmission element 20. The light guide element 40 may comprise a light incident face 41 and a light exit face 42. The light incident face 41 faces the light emitting element 30. In other words, the light incident face 41 may be adjacent to the light emitting element 30, that is, the light incident face 41 may attached to a light exit surface of the light emitting element 30, or the light incident face 41 is apart from and corresponding to the light exit surface of the light emitting element 30. The light exit face 42 may face the light transmission element 20. In this embodiment, two light emitting elements 30 are respectively disposed on two opposite sides of one light guide element 40 (as shown in FIG. 4).

The light incident face 41 is used to receive the light emitted from the light emitting element 30, and the shape of the light incident face 41 can also correspond to the shape of the light emitting element 30. The light incident face 41 may be a smooth surface to avoid the reduction of the efficiency of the light entering the light incident face 41 due to the generation of the effects such as light diffusion caused by the roughness of the surface of the light incident face 41 when the light emitted from the light emitting element 30 enters the light incident face 41.

The light guide element 40 is made of a material different from the external air, that is, the refractive index of the light guide element 40 is different from that of the external air. With the difference of the refractive indexes, the light will be restricted within the light guide element 40 to be refracted and transmitted after entering the light guide element 40 through the light incident face 41. After the refraction of the light, the light can be emitted from the light exit face 42 and leave the light guide element 40.

Therefore, when the user displaces an object on the touch area A, the touch pad 10 can detect a moving track of the object on the touch area A, such that a moving direction of the object on the touch area A is determined. Taking this embodiment as an example, the touch area A is rectangular (quadrangular). Thus, when an object (such as a finger or a digital pen) contacts with the touch area A and moves thereon, the induction circuit 11 of the touch pad 10 may generate a variation of a capacitance value corresponding to a moving track direction of the object on the touch area A. In such a manner, the touch pad 10 may obtain an analog signal corresponding to the variation of the capacitance value, and the analog signal is transmitted to a controller (not shown) to be converted into a digital signal. Then, a computer operation unit (not shown) calculates the moving track direction of the object on the touch area A with the analog signal. In this way, the computer operation unit (not shown) can activate the light emitting element 30 corresponding to the moving track direction to perform the operation. The light incident face 41 of the light guide element 40 receives the light emitted from the light emitting element 30. With the difference between the refractive indexes of the light guide element 40 and the external air, the light is restricted within the light guide element 40 to be refracted and transmitted. Finally, the light leaves the light guide element 40 through the light exit face 42, and is distributed to the light transmission element 20.

In other words, when the object (such as the finger or the digital pen) moves on the touch area A, the moving track direction of the object can be determined by the induction circuit 11, such that the light emitting element 30 corresponding to the moving track direction is driven to perform the operation. The light transmission elements 20 corresponding to the moving track direction of the object integrally illuminate to act as a light source indication, and the light transmission elements 20 may form a luminous area with a large area around the touch pad 10. Also, in places with no illumination or undesirable illumination, the light transmission element 20 forms a luminous border area around the touch pad 10 to indicate the current touch direction and border of the user, so as to increase the convenience in operating the electronic device. However, the light guide element 40 is only a preferable embodiment, but the present invention is not limited thereto, and the light emitting element 30 (such as the cold cathode lamp) may be used to directly emit a light to the light transmission element 20.

Again, in the description of the embodiment of the present invention, the touch pad 10 is disposed in the electronic device 200, and is a touch pad device having separate operation functions, for example, the touch pad 10 (comprises but not limited to a resistance touch pad or a capacitance touch pad) acts as the manipulation function of the cursor of the electronic device 200, or acts as the manipulation function of the handwritten input of the electronic device 200.

It should be noted that, the touch pad 10, in addition to detecting the touch movement of the object (for example, the touch pad 10 uses the variation of the resistance value or the capacitance value as the detection of coordinates or offset to output a mouse moving track signal or a handwritten input signal), can also simultaneously act as determination of detecting the moving track direction of the object.

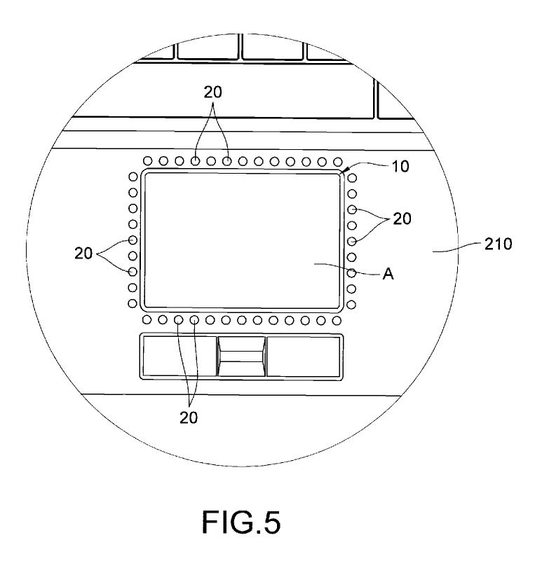

FIG. 5 is a schematic top view of an optical touch module according to another embodiment of the present invention. In this embodiment, the structure of the optical touch module 10 is substantially the same as the structure in the previous embodiment. Hence, the same components are represented with the same reference numerals, and the descriptions thereof are omitted.

Particularly, a plurality of light transmission elements 20 is disposed on one side of the touch pad 10. In other words, a plurality of notches (not shown) is cut on the housing 210 of the electronic device 200, and the notches are located on at least one side of the touch pad 10. The light transmission elements 20 are designed to be circular, and the light transmission elements 20 are inserted into the notches. When the light guide element 40 guides the light to the light transmission elements 20, the light transmission elements 20 assume a state of a multi-point light source on the sides of the touch pad 10.

Certainly, in other embodiments of the present invention, the plurality of the light transmission elements 20 can also be designed to be stripe-shaped or circular, and the stripe-shaped light transmission elements 20 or circular light transmission elements are combined together to be disposed on at least one side of the touch pad 10. Such a design about the variation of the structure falls within the protection scope of the present invention.

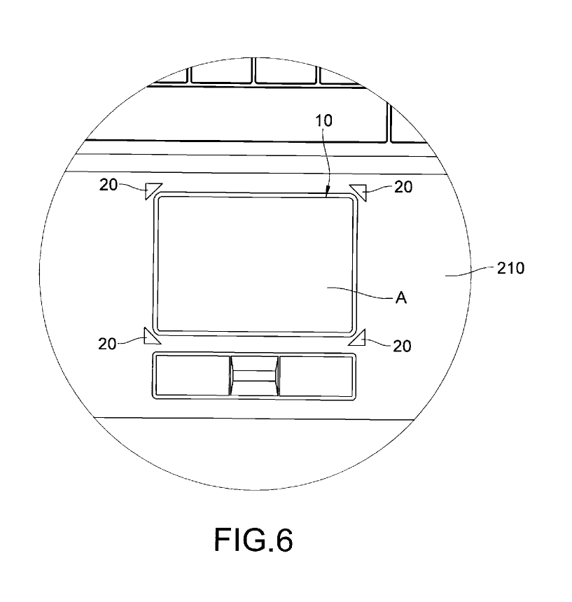

FIG. 6 is a schematic top view of an optical touch module according to still another embodiment of the present invention. In this embodiment, the structure of the optical touch module 10 it is substantially the same as the structure in the previous embodiments. Hence, the same components are represented with the same reference numerals, and the descriptions thereof are omitted.

Particularly, at least one light transmission element 20 is disposed in at least one corner of the touch pad 10. In this embodiment, the number of the light transmission elements 20 may be four, and the light transmission elements 20 are designed to be triangular, but the present invention is not limited thereto. When the object moves on the touch area A, the light transmission element 20 in the corner of the touch pad 10 illuminate correspondingly according to the moving direction of the object. Certainly, the design of this embodiment that the light transmission elements 20 are disposed at the corners of the touch pad 10 can also be combined with the design of the stripe-shaped or circular light transmission elements in the previous embodiments. Such a design about the variation of the structure falls within the protection scope of the present invention.

What is claimed is:

1. An electronic device with an optical touch module, comprising:
a housing;
a touch pad, disposed on the housing and having at least one induction circuit, wherein the induction circuit constitutes a touch area on the touch pad, and the touch pad detects a moving track direction of an object in the touch area;
at least one light transmission element, disposed on the housing and being adjacent to at least one side of the touch pad; and
at least one light emitting element, disposed in the housing and corresponding to the light transmission element, wherein the touch pad, according to the moving track direction of the object, activates the light emitting element to emit a light to the light transmission element corresponding to the moving track direction.

2. The electronic device with the optical touch module according to claim 1, wherein the induction circuit is a capacitance induction circuit or a resistance induction circuit.

3. The electronic device with the optical touch module according to claim 1, wherein the light emitting element is a light emitting diode (LED), a cold cathode lamp, or a lamp.

4. The electronic device with the optical touch module according to claim 1, further comprising at least one light guide element, disposed in the housing and corresponding to the light transmission element, wherein the light guide element further comprises a light incident face and a light exit face, the light incident face faces the light emitting element, and the light exit face faces the light transmission element.

5. The electronic device with the optical touch module according to claim 1, further comprising a plurality of light transmission elements, wherein the light transmission elements are disposed on four sides of the touch pad respectively.

6. The electronic device with the optical touch module according to claim 1, further comprising a plurality of light transmission elements, wherein the light transmission elements are disposed on at least one side of the touch pad.

7. The electronic device with the optical touch module according to claim 1, further comprising a plurality of light transmission elements, wherein the light transmission elements are disposed in four corners of the touch pad respectively.
